(19) United States
(12) Patent Application Publication
(10) Pub. No.: US 2006/0287468 A1
(43) Pub. Date: Dec. 21, 2006

(54) Polyimide resin and method of preparing the same

(76) Inventors: Kuen-Yuan Hwang, Hsinchu (TW); An-Pang Tu, Hsinchu (TW); Sheng-Yen Wu, Hsinchu (TW)

Correspondence Address: FULBRIGHT AND JAWORSKI LLP, 555 S. FLOWER STREET, 41ST FLOOR, LOS ANGELES, CA, 90071, US

(21) Appl. No.: 11/442,501

(22) Filed: May 26, 2006

(30) Foreign Application Priority Data
May 30, 2005 (TW) 094117629

(51) Int. Cl. C08G 73/00

(52) U.S. Cl. 528/170

(57) ABSTRACT

The present invention provides a polyimide resin formed by polycondensating a dianhydride monomer including at least a dianhydride monomer represented by formula (I) 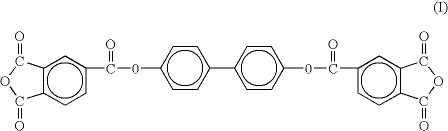 and a diamine monomer to form a polyamic acid resin, and then cyclodehydrating the polyamic acid. Through using the dianhydride monomer of formula (I) as the polymerizing unit, a biphenyl moiety is introduced into the main chain of polyimide resin, such that the resulting polyimide resin has lower moisture absorption and smaller thermal expansion coefficient, as well as satisfactory heat resistance and dimensional stability.

### FIELD OF THE INVENTION

The present invention relates to a polyimide resin, especially those formed by a dianhydride monomer and a diamine monomer, and a method of preparing the same.

### BACKGROUND OF THE INVENTION

Recently, with the increasing demand for miniaturization of electronic and communication devices, the integrated circuit packages therein tend to become smaller and thinner and circuits also become finer. Among various types of printed circuit boards, flexible printed circuit boards are widely used because they can greatly reduce the volume and the weight of an electronic device.

Generally, a flexible printed circuit board comprises an insulating substrate and a metal layer. The insulating substrate is adhered to the metal layer by an adhesive. The metal layer is usually consisting of a copper foil. Polyimide resins are widely used as insulating substrates due to their good heat resistance, chemical resistance, and excellent mechanical and electrical properties. The adhesives for bonding the insulating substrate and the metal layer are usually epoxy resins or acrylic resins. However, these adhesives have poor heat resistance and hence easily cause cracking during the sequential step of curing resin, which in turn results in reduction of the dimension stability of the printed circuit boards. To solve this problem, it has been attempted to incorporate a rubber elastomer into the adhesive to prevent the occurrence of cracking. Nevertheless, rubber elastomers have poor heat stability and will degrade during high temperature process, which in turn will result in lowering the physical properties of flexible printed circuit boards (FPC).

Furthermore, the thermal expansion coefficient of the polyimide resin layer is different from that of the metal layer, therefore the laminated plate may curl or have residual internal stress in a high temperature process, which, in turn, resulting in lower yield. JP 2002-322292 disclosed use of nanoclay to adjust the thermal expansion coefficient of polyimide resin. However, nanoclay may have metal ion residues, which will affect the electrical properties of the polyimide resin layer.

The properties of the polyimide resin layer itself will affect the quality of the laminated plate. When a polyimide resin contains more amide groups, moisture absorption will increase and decomposition of amide groups into amino groups and acid groups may occur. Introduction of some other functional groups into the main chain of a polyimide resin may reduce moisture absorption. However, higher ratio of long-chain monomers may decrease elasticity and increase thermal expansion coefficient of the polyimide resin layer, leading to lower dimensional stability of the laminated plate prepared therefrom.

Therefore, there is still a demand for polyimide resin that has reduced moisture absorption, smaller thermal expansion coefficient, and good heat resistance and processability.

### SUMMARY OF THE INVENTION

One object of the present invention is to provide a polyimide resin with lower moisture absorption.

Another object of the present invention is to provide a polyimide resin with smaller thermal expansion coefficient.

Still another object of the present invention is to provide a polyimide resin with high peeling strength.

Still another object of the present invention is to provide a polyimide resin with high dimensional stability.

Still another object of the present invention is to provide a polyimide resin with excellent heat resistance.

To achieve the above and other objects, the present invention provides a polyimide resin formed by polycondensating a dianhydride monomer including at least a dianhydride represented by formula (I) 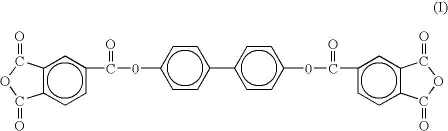
and a diamine monomer, and then imidizing the resulting polyamic acid.

Through using the dianhydride monomer of formula (I) as the polymerizing unit, a biphenyl moiety is introduced into the main chain of polyimide resin, such that the resulting polyimide resin has lower moisture absorption and smaller thermal expansion coefficient, as well as satisfactory heat resistance and dimensional stability.

The present invention further provides a method of preparing polyimide resin, comprising polycondensating a dianhydride monomer including at least a dianhydride represented by formula (I) and a diamine monomer in an aprotic solvent to form a polyamic acid resin and then imidizing said polyamic acid resin to form a polyimide resin.

The polyimide resin of the present invention can be used in manufacturing a flexible printed circuit board by forming a film of the polyimide resin and then applying the film to the metal layer, or applying the polyamic acid (intermediate) to the metal layer and then imidizing the polyamic acid resin to form a polyimide resin layer.

### DETAILED DESCRIPTION OF THE INVENTION

The present invention are now illustrated by the following specific embodiments. Persons skilled in the art can easily realize the advantages and effects of the present invention according to the disclosed contents in the specification. The present invention may be executed or applied with other different embodiments, and any details in the specification may be modified or varied based on different points of view and applications without departing from the spirit of the present invention.

The polyimide resin of the present invention is prepared by polycondensating a dianhydride monomer including at least a dianhydride represented by formula (I) 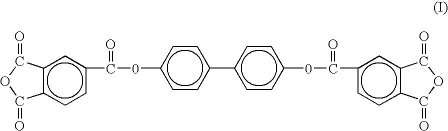
and a diamine monomer in an aprotic solvent to form a polyamic acid resin and then imidizing said polyamic acid resin.

Through using the dianhydride monomer represented by formula (I) as the polymerizing unit, a biphenyl moiety is introduced into the polyimide resin such that the polyimide resin has reduced moisture absorption and smaller thermal expansion coefficient. As a result, the polyimide resin of the present invention has improved processing stability and dimensional stability due to reduced moisture absorption. Furthermore, the polyimide resin of the present invention has a thermal expansion coefficient closer to that of metal layer such as copper foil, and therefore the wiring board produced therefrom will less curled and deformed in a high temperature process.

The diamine monomer used in the present invention may be, for example, a diamine monomer represented by the formula (II):
H₂N—Ar—NH₂ (II)
In which Ar represents an aromatic group selected from:

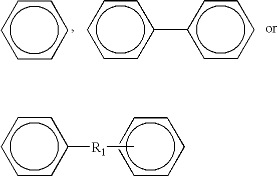

wherein R₁ represents S, O, a carbonyl group or a C₁-C₆ alkylene group.

The diamine monomers may comprise one or more monomers of formula (II), for example, phenylenediamine such as p-phenylenediamine (p-PDA) and oxydianiline such as 4,4′-oxydianiline (4,4′-ODA).

In a preferred embodiment of the present invention, the diamine monomers consist of 5 to 95 mol % of phenylenediamine and 5 to 95 mol % of oxydianiline, based on the total moles of the diamine monomers.

The dianhydride monomers used in the present invention may comprise, in addition to the dianhydride monomer of formula (I), one or more other dianhydride monomers including, but not limited to, 3,3′,4,4′-benzophenone-tetracarboxylic dianhydride (BTDA), and 3,3′,4,4′-biphenyltetracarboxylic dianhydride (BPDA).

In a preferred embodiment of the present invention, the dianhydride monomer comprises 5 to 20 mol % of the dianhydride monomer of formula (I), 75 to 40 mol % of 3,3′,4,4′-benzophenonetetracarboxylic dianhydride (BTDA), and 20 to 40 mol % of 3,3′,4,4′-biphenyltetracarboxylic dianhydride (BPDA), based on the total moles of the dianhydride monomers. The dianhydride monomer of formula (I) is also referred to PBTDA.

PBTDA can be prepared by the conventional methods. For example, PBTDA was prepared by reacting trimellitic acid anhydride chloride with a glycol in a solvent such as benzene and toluene. Further, PBTDA can be prepared by condensing trimelltic anhydride (TMA) with 4,4′-dihydroxybiphenyl as shown in Reaction Scheme 1.

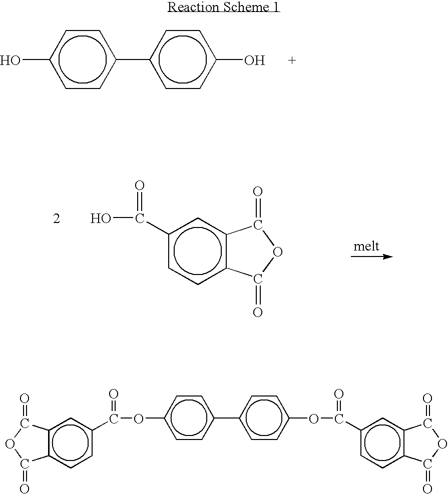

According to the present invention, the molar ratio of the dianhydride monomers to the diamine monomers is preferably 0.75 to 1.25, and more preferably 0.9 to 1.1.

Polyimide resin of the present invention is prepared as follows. To a solution of a diamine monomer in an aprotic solvent, a solution of a dianhydride monomer in an aprotic solvent is portionwise added and polycondensation of the dianhydride monomer and the diamine monomer is carried out to form polyamic acid resin. Polyamic acid resin is then imidized to form polyimide resin.

The aprotic solvents suitable for use in polycondensation include, but are not limited to, N-methyl-2-pyrrolidone (NMP), dimethyl acetamide (DMAC), dimethyl formamide (DMF) and mixtures thereof. Other organic solvents may be added to the aprotic solvent. Said other organic solvents include, but are not limited to, benzene, toluene, cyclohexanol and a mixture thereof. The organic solvent is used in an amount that will not cause precipitation of the polyamic acid resin.

Polycondensation of dianhydride monomers and diamine monomers is performed preferably at a temperature of 0 to 100° C., more preferably 0 to 80° C. The resulting solution of polyamic acid resin preferably has a solid content of 5 to 50% by weight, more preferably 10 to 30% by weight, based on the total weight of the solution.

Polyimide resin of the present invention can be used in, for example, manufacturing two-layer flexible printed circuit boards (FPC), wherein the polyimide resin layer usually has a thickness of 5 to 100 μm; and the metal layer is selected from a copper foil, an aluminum foil, a nickel foil, an iron foil or the like. If a copper foil is used, it can be an electrolytically deposited copper foil or a rolled copper foil, usually having a thickness of 12.5 to 50 μm. For manufacturing the flexible printed circuit board, the polyamic acid resin is first coated on the rough surface of the metal foil with a die coater, a lip coater, or a roll coater. After coated, the foil is baked stepwise in an oven to remove the solvent until the solvent content is less than 20%. The baking temperature is typically 110 to 200° C., preferably 120 to 180° C. The speed is typically 0.5 to 10 m/min, preferably 2 to 7 m/min.

The polyamic acid resin is then imidized to form polyimide resin by curing in an oven at high temperature, for example, 200 to 400° C., preferably 250 to 350° C. Curing can be performed in a continuous mode or in batch. Curing is preferably performed in a nitrogen gas or inert gas atmosphere to protect metal layer from oxidation during heating.

Polyimide resin of the present invention has excellent heat resistance and high bonding strength, and hence can avoid the disadvantages of poor heat resistance of epoxy resin adhesives or acrylic resin adhesives. These adhesives of the prior art may degrade at high temperature, leading to lowering the quality of FPC boards. The polyimide resin of the present invention is thus suitable for use in packaging electronic means or electronic members.

The following examples are provided to further illustrate the features and effects of the present invention. The details of the examples are only used to illustrate the present invention but not to limit the scope of the invention.

### EXAMPLES

The Abbreviations Used in the Examples Have the Following Meanings:

PBTDA

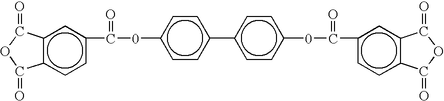

BTDA: 3,3′,4,4′-benzophenonetetracarboxylic acid dianhydride

BPDA: 3,3′,4,4′-biphenyltetracarboxylic acid dianhydride

p-PDA: p-phenylenediamine

4,4′-ODA: 4,4′-oxydianiline

NMP: N-methyl-2-pyrrolidone

DMAC: dimethylacetamide

DMF: dimethylformamide

Test Method of Physical Properties

(1) Moisture absorption: according to the method of IPC TM-650 2.6.2

(2) Thermal expansion coefficient: determined by the TMA method

(3) Elongation: according to the method of IPC TM-650 2,4,19

(4) Tensile strength: according to the method of IPC TM-650 2.4.19

(5) Solder float resistance: according to the method of IPC TM-650 2.4.13

(6) Peeling strength: according to the method of IPC TM-650 2.4.9

### Example 1

In a four-necked flask equipped with a mechanic stirrer and a nitrogen inlet, 6.48 g (0.06 moles) of p-PDA, 8.01 g (0.04 moles) of 4,4′-ODA and 100 g of NMP were charged and mixed with stirring at a temperature of 15° C. and at a nitrogen flow rate of 20 cc/min. After p-PDA and 4,4′-ODA were completely dissolved, 50 g of toluene was added.

Three flasks, each equipped with a stirring bar were used. To the first flask, 5.77 g (0.02 moles) of BPDA and 20 g of NMP were charged and mixed with stirring until BPDA was completely dissolved. To the second flask, 2.67 g (0.005 moles) of PBTDA and 10 g of NMP were charged and mixed with stirring until PBTDA was completely dissolved. The solutions in the first and the second flasks were added into the above four-necked flask and the content is mixed with stirring in a nitrogen atmosphere for 15 minutes.

To the third flask, 24.17 g (0.075 moles) of BTDA and 90 g of NMP were charged and mixed with stirring until BTDA was completely dissolved. The solution in the third flask was added portionwise to the four-necked flask at 30 minute intervals for each portion. The mixture was reacted at 15° C. in a nitrogen atmosphere for 4 hours, and a polyamic acid resin was obtained.

0.5 g of the polyamic acid resin thus prepared was dissolved in 15 g of NMP, then the intrinsic viscosity of the resulting solution was measured with a viscometer at 25° C. The intrinsic viscosity (IV) was 1.1 dl/g.

### Examples 2 to 8

Polyamic acid resins of Examples 2 to 8 were synthesized in the same manner as Example 1, except each monomer was used in an amount (expressed by mole) specified in Table 1.

### Comparative Example 1

In a four-necked flask equipped with a mechanic stirrer and a nitrogen inlet, 6.48 g e(0.06 mole) of p-PDA, 8.01 g (0.04 mole) of 4,4′-ODA and 100 g of NMP were charged and mixed with stirring at a temperature of 15° C. and a nitrogen flow rate of 20 cc/min. After p-PDA and 4,4′-ODA were completely dissolved, 50 g of toluene was added.

Two flasks equipped with a stirring bar were used. To the first flask, 5.88 g (0.02 mole) of BPDA and 20 g of NMP were added and mixed with stirring until BPDA was completely dissolved. The resulting solution in the first flask was added to the four-necked flask and mixed with stirring for 15 minutes in a nitrogen atmosphere. To the second flask, 25.776 g (0.08 mole) of BTDA and 90 g of NMP were added and mixed with stirring until BTDA was completely dissolved. The resulting solution in the second flask was added to the four-necked flask portionwise at 30 mintue intervals for each portion. The mixture was reacted at 15° C. in a nitrogen atmosphere for 4 hours, and a polyamic acid resin was obtained.

0.5 g of the polyamic acid resin thus prepared was dissolved in 15 g of NMP, then the intrinsic viscosity of the resulting solution was measured with a viscometer at 25° C. The intrinsic viscosity (IV) was 1.3 dl/g.

### Comparative Example 2

A polyamic acid resin was synthesized in the same manner as Comparative Example 1, except each monomer was used in an amount (expressed by mole) specified in Table 1.

TABLE 1

| | Monomer (mole) | | | | | |
|---|---|---|---|---|---|---|
| | BPDA | BTDA | PBTDA | ODA | PDA | IV* (dl/g) |
| Example 1 | 0.02 | 0.075 | 0.005 | 0.04 | 0.06 | 1.1 |
| Example 2 | 0.02 | 0.070 | 0.010 | 0.04 | 0.06 | 1.3 |
| Example 3 | 0.02 | 0.065 | 0.015 | 0.04 | 0.06 | 1.2 |
| Example 4 | 0.02 | 0.060 | 0.020 | 0.04 | 0.06 | 1.2 |
| Example 5 | 0.02 | 0.075 | 0.005 | 0.01 | 0.09 | 1.4 |
| Example 6 | 0.02 | 0.075 | 0.005 | 0.02 | 0.08 | 1.0 |
| Example 7 | 0.02 | 0.075 | 0.005 | 0.03 | 0.07 | 1.3 |
| Example 8 | 0.02 | 0.075 | 0.005 | 0.005 | 0.0095 | 1.2 |
| Comparative | 0.02 | 0.08 | | 0.04 | 0.06 | 1.3 |
| Example 1 | | | | | | |
| Comparative | 0.04 | 0.060 | | 0.02 | 0.08 | 1.0 |
| Example 2 | | | | | | |

*IV: intrinsic viscosity

The polyamic acid resin synthesized above was coated on a metal foil such as a copper foil, and the coated foil was baked in an oven to remove the solvent. Then, the coated foil was heated in an oven in a nitrogen atmosphere, at a temperature of 250° C. for 20 minutes, 300° C. for 30 minutes and 350° C. for 60 minutes temperature, such that the polyamic acid resin was converted to polyimide resin by cyclodehydration and a copper clad laminate (CCL) having a polyimide resin layer with a thickness of 25 μm was obtained. The physical properties of the copper clad laminate were determined by the standard methods as stated above, and the results were listed in the Table 2.

TABLE 2

| | | | | | | Solder |
|---|---|---|---|---|---|---|
| | | | Thermal | | | Float |
| | Peeling | Moisture | Expansion | | Tensile | Resistance |
| | Strength | Absorption | Coefficient | Elongation | Strength | (288° C., |
| | (kgf/cm) | (%) | 10⁻⁶(K⁻¹) | (%) | (kg/mm²) | 10 sec) |
| Example 1 | 1.42 | 1.9 | 33 | 30 | 21 | Pass* |
| Example 2 | 1.55 | 1.7 | 30 | 32 | 23 | Pass |
| Example 3 | 1.88 | 1.5 | 25 | 38 | 22 | pass |
| Example 4 | 2.10 | 1.2 | 23 | 43 | 25 | Pass |
| Example 5 | 1.45 | 1.5 | 30 | 27 | 22 | Pass |
| Example 6 | 1.54 | 1.8 | 29 | 29 | 23 | Pass |
| Example 7 | 1.48 | 1.7 | 33 | 31 | 24 | Pass |
| Example 8 | 1.52 | 1.9 | 35 | 30 | 22 | Pass |
| Comparative | 0.97 | 2.5 | 38 | 23 | 23 | Pass |
| Example 1 | | | | | | |
| Comparative | 1.02 | 2.3 | 22 | 17 | 20 | Pass |
| Example 2 | | | | | | |

*pass: no opaque or float occurs.

The polyimide resin according to the present invention has low moisture absorption (for example, lower than 2.0%), small thermal expansion coefficient (for example, 20 to 35 ppm at 100 to 250° C.) and excellent processibility (for example, elongation is 20% or more). The flexible wiring board composed of the polyimide resin according to the present invention and the metal layer exhibits higher performance.

The aforesaid embodiments illustrate the principles and effects of the present invention, but are not intended to limit the present invention in any aspects. It will be apparent to the persons skilled in the art that various alteration and modification can be made to these embodiments without departing from the spirit of the present invention, and the scope of the present invention is as set forth in the following claims.

What is claimed is:

1. A polyimide resin formed by polycondensating a dianhydride monomer comprising at least a dianhydride represented by formula (I) 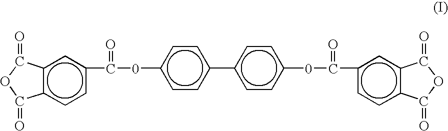
and a diamine monomer to form a polyamic acid resin, and then imidizing the polyamic acid resin.

2. The polyimide resin according to claim 1, wherein the diamine monomer comprises a diamine represented by the formula (II):
H₂N—Ar—H₂N (II)
wherein Ar represents: 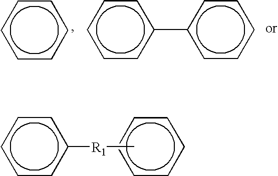
wherein R₁ represents S, O, a carbonyl group or a C₁₋₆ alkylene group.

3. The polyimide resin according to claim 1, wherein the molar ratio of the dianhydride monomer to the diamine monomer is 0.75 to 1.25.

4. The polyimide resin according to claim 1, wherein the molar ratio of the dianhydride monomer to the diamine monomer is 0.9 to 1.1.

5. The polyimide resin according to claim 1, wherein the dianhydride monomer further comprises 3,3′,4,4′-benzophenone tetracarboxylic dianhydride and 3,3′,4,4′-biphenyltetracarboxylic dianhydride.

6. The polyimide resin according to claim 5, wherein the dianhydride monomer comprises 5 to 20 mol % of a dianhydride represented by the formula (I), 40 to 75 mol % of 3,3′,4,4′-benzophenone tetracarboxylic dianhydride and 20 to 40 mol % of 3,3′,4,4′-biphenyltetracarboxylic dianhydride, based on the total moles of the dianhydride monomer.

7. The polyimide resin according to claim 2, wherein the diamine monomer comprises 5 to 95 mol % of p-phenylene diamine and 5 to 95 mol % of 4,4′-oxydianiline, based on the total moles of the diamine monomer.

8. A method for preparing a polyimide resin, comprising the steps of:
(a) polycondensating a dianhydride monomer comprising at least a dianhydride represented by formula (I) 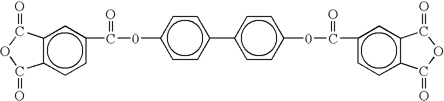
and a diamine monomer in an aprotic solvent to form a polyamic acid resin; and
(b) cyclodehydrating said polyamic acid resin to form a polyimide resin.

9. The method according to claim 8, wherein the diamine monomer comprises a diamine monomer represented by the formula (II):
H₂N—Ar—H₂N (II)
wherein Ar represents: 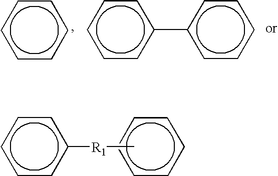
wherein R₁ represents S, O, a carbonyl group or a C₁₋₆ alkylene group.

10. The method according to claim 9, wherein the diamine monomer comprises 5 to 95 mol % of p-phenylene diamine and 5 to 95 mol % of 4,4′-oxydianiline, based on the total moles of the dianhydride monomer.

11. The method according to claim 8, wherein the dianhydride monomer comprises 5 to 20 mol % of a dianhydride represented by the formula (I), 40 to 75 mol % of 3,3′,4,4′-benzophenone tetracarboxylic dianhydride and 20 to 40 mol % of 3,3′,4,4′-biphenyltetracarboxylic dianhydride, based on the total moles of the dianhydride monomer.

12. The method according to claim 8, wherein the aprotic solvent is selected from a group consisting of N-methyl-2-pyrrolidone, N,N-dimethylacetamide and N,N-dimethylformamide.

13. The method according to claim 8, wherein an organic solvent selected from a group consisting of benzene, toluene, hexane, cyclohexanol or a mixture thereof is added to the aprotic solvent.

14. The method according to claim 8, wherein the polycondensation in step (a) is performed at a temperature of 0 to 100° C.

15. The method according to claim 8, further comprising a step of coating the polyamic acid obtained in step (a) on a metal foil between the step (a) and step (b).

16. The method according to claim 15, wherein the polyamic acid obtained in step (a) has a solid content of 5 to 50% by weight.

17. The method according to claim 15, wherein the polyamic acid obtained in step (a) has a solid content of 10 to 30% by weight.

18. The method according to claim 15, wherein the metal foil is selected from a group consisting of a copper foil, an aluminum foil, a nickel foil and an alloy foil.

19. The method according to claim 18, wherein the copper foil is an electrolytically deposited copper foil or a rolled copper foil.

20. The method according to claim 18, wherein the metal foil has a thickness of 9 to 70 μm.
